(19) United States
(12) Patent Application Publication
(10) Pub. No.: US 2007/0258052 A1
(43) Pub. Date: Nov. 8, 2007

(54) IMAGE FORMING APPARATUS AND LIGHT-SHIELDING DEVICE THEREOF

(75) Inventors: Chi-Hung Hsiao, Banqiao City (TW); Hsu-Hsin Huang, Yuanlin Town (TW); Chun-Ming Shen, Taipei City (TW)

Correspondence Address: SNELL & WILMER L.L.P. (Main), 400 EAST VAN BUREN, ONE ARIZONA CENTER, PHOENIX, AZ, 85004-2202, US

(73) Assignee: BENQ CORPORATION, Taoyuan (TW)

(21) Appl. No.: 11/739,419

(22) Filed: Apr. 24, 2007

(30) Foreign Application Priority Data
May 5, 2006 (TW) 95116022

(51) Int. Cl. G03B 21/26

(52) U.S. Cl. 353/34

(57) ABSTRACT

An image forming apparatus includes a light source, an optical component, and a light-shielding device disposed between the light source and the optical component. The light-shielding device includes a first component and a second component. The first component includes a circular element and a frame. The first component has an aperture for allowing light emitted from the light source incident onto the optical component. At least one opening is formed in the frame. The second component is coupled to the first component and covers the opening.

### CROSS REFERENCE TO RELATED APPLICATIONS

This application claims the right of priority based on Taiwan Patent Application No. 095116022 entitled “IMAGE FORMING APPARATUS AND LIGHT-SHIELDING DEVICE THEREOF,” filed on May 5, 2006, which is incorporated herein by reference and assigned to the assignee herein.

### FIELD OF INVENTION

The present invention relates to an electronic apparatus, and particularly, to an image forming apparatus and a light-shielding device thereof.

### BACKGROUND OF THE INVENTION

Typical full-color display apparatuses produce images by projecting three monochromic colors, i.e., red, blue, and green. Through viewer's eyes, these outputted monochromic colors are combined to present a full-color visual effect. In recent years, projectors have become essential to a variety of activities. Meanwhile, the imaging technology has evolved from pervious LCD display technology to advanced digital light processing (DLP).

Generally, in order to output a full-color image, an image forming apparatus has a color wheel incorporated with red, green, and blue color filters. The color wheel filters light to present the corresponding colors, and then the subsequent optical component displays the colors for each pixel of an image.

A typical color wheel is a disk-like wheel with several color filters. But color wheels of other types are available, e.g., a rotating color drum, or a polygonal color wheel. When the white light from the light source is incident onto the color wheel, the color filters filter the white light to present three primary monochromic lights. Generally, the rotating of the color wheel should be fast enough that one primary monochromic light could be presented for a period of time during the procedure for outputting the image. Therefore, the rotating speed of the color wheel and the incident angle related to the color wheel would affect the presented colors of the image.

In addition, the increasing output power of the light source results in a higher ambient temperature, which affects the filtering efficiency of the color wheel. Moreover, in order to improve the image quality, it is critical to ensure that the light from the light source is incident onto the color wheel at a predetermined angle, as well as to prevent that undesired lights from the surroundings from reaching the color wheel.

Therefore, it is necessary to provide an image forming apparatus having a light-shielding device, which can prevent undesired stray lights from reaching the color wheel and improve the thermal problems.

### SUMMARY OF THE INVENTION

One aspect of the present invention is to provide an image forming apparatus with a light-shielding device having high reflective ratio and low thermal radiation so as to efficiently decrease the amount of the undesired stray light reaching the optical component, and also provide a better thermal dissipation mechanism.

Another aspect of the present invention is to provide an assembled light-shielding device, which results in a thicker gas layer for better thermal dissipation.

Yet another aspect of the present invention is to provide a light-shielding device with a saucer-like sunk surface. When an optical component rotates at a high speed, the saucer-like sunk surface disturbs the gas flow to cool down the optical component.

In one embodiment, disclosed is an image forming apparatus including a light source, an optical component, and a light-shielding device. The light-shielding device includes a first component and a second component. The first component includes a circular element and a frame. An aperture is formed in the circular element, and the aperture allows light emitted from the light source incident onto the optical component. At least one opening is formed in the frame. The second component is coupled to the first component for covering the opening. In addition, the second component includes a second aperture, and the second aperture corresponds to the aperture of the first component.

In an embodiment, the first component is thicker than the second component, and the thickness of the second component is between 0.05 and 0.1 mm. For example, the second component is a flexible metal sheet, and the first component is a rigid metal frame. Further, the reflectivity of the second component is greater than the reflectivity of the first component.

In an embodiment, the circular element protrudes over the frame and extends toward the optical component, so that the circular element is closer to the optical component than the frame. The circular element is a curved-surface structure, and the frame is a plane structure; and the curved-surface structure extends from the frame. In another embodiment, the circular element further includes an extension portion, and the extension portion extends toward the optical component.

In still another embodiment, the second component includes a second curved-surface structure corresponding to the curved-surface structure. When the second component is coupled to the first component, the second curved-surface structure overlaps the curved-surface structure. In addition, the second curved-surface structure includes a plurality of reflective surfaces, and the surfaces have different radians. In another embodiment, when the second component is engaged with the first component, a slit between the first component and the second component allows gas to flow between the first component and the second component. The second component is provided with the surface treatment, the polished Sn-coating treatment, or the polished anode treatment. In yet another embodiment, the first component further includes a connecting portion for connecting to the light source.

In an alternative embodiment, the present invention provides a light-shielding device including a frame and circular element. The circular element protrudes over the frame and extends toward the optical component, so that the circular element is closer to the optical component than the frame. An aperture is formed in the circular element and the aperture allows light emitted from the light source incident onto the optical component. Further, the material of the light-shielding device has a reflectivity greater than 0.8.

### BRIEF DESCRIPTION OF THE DRAWINGS

The present invention is illustrated by way of example and not intended to be limited by the figures of the accompanying drawing, in which like notations indicate similar elements.

FIG. 1 illustrates an image forming apparatus according to an embodiment of the present invention in three dimensions;

FIGS. 2A and 2B illustrate a light-shielding device according to an embodiment of the present invention in an exploding mode and in an assembling mode;

FIGS. 3A and 3B illustrate a first component of a light-shielding device according to an embodiment of the present invention from the top view and from the side view;

FIGS. 4A and 4B illustrate a second component of a light-shielding device according to an embodiment of the present invention from the top view and from the side view; and

FIGS. 5A, 5B and 5C illustrate a light-shielding device according to another embodiment of the present invention in three directions.

### DETAILED DESCRIPTION

The present invention is directed to an image forming apparatus and a light-shielding device thereof, which is capable of reducing the thermal radiation accumulated on the light-shielding device and improving the thermal environment of the optical component, so as to improve the quality of the image. The foregoing and other features of the invention will be apparent from the following more particular description and figures of embodiments of the invention.

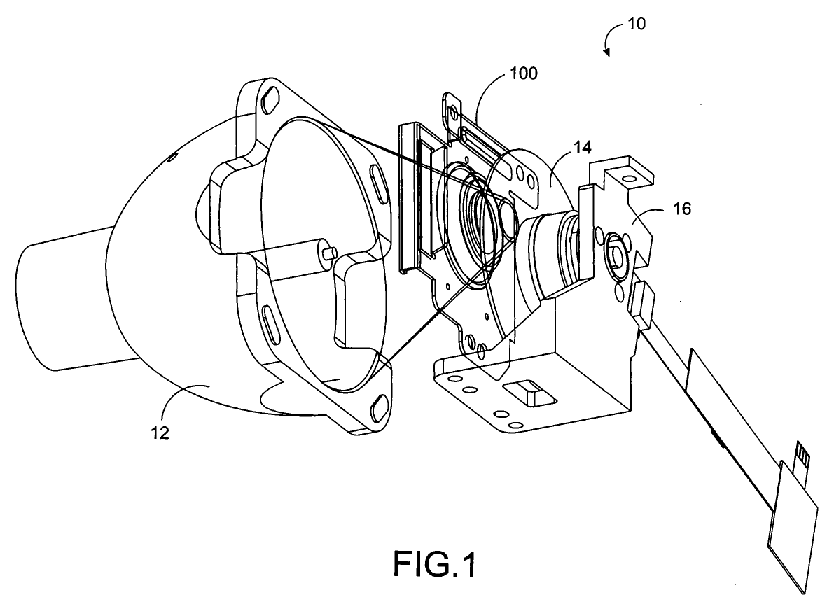

FIG. 1 illustrates an image forming apparatus 10 according to an embodiment of the present invention. In this embodiment, the image forming apparatus 10 is a projector, but any other electronic device that requires a light-shielding device can incorporate the present invention. Taking the image forming apparatus 10 as a projector for example, the image forming apparatus 10 has a light source 12, an optical component 14, and a light-shielding device 100. The optical component 14 includes a light separation device, e.g., a color wheel. Those skilled in the art should understand the optical component of the present invention is not limited to a color wheel.

The light source 12 provides light incident onto the color wheel 14. A driving device 16 is configured to rotate the color wheel 14 according to image signals, so that the light incident on the color wheel 14 is filtered to be a light of specific color. Then through a subsequent optical system, the filtered light is projected onto the screen to present an image. As shown in FIG. 1, the light-shielding device 100 is disposed between the light source 12 and the color wheel 14, in order to prevent the undesired surrounding light from reaching the color wheel 14 and thus obtain a better image. Note that in addition to the components mentioned above, the image forming apparatus 10 may have other components, such as a lens, an image signal controller, or any other components known to those skilled in the art, and thus are omitted hereinafter for the clarity of the invention.

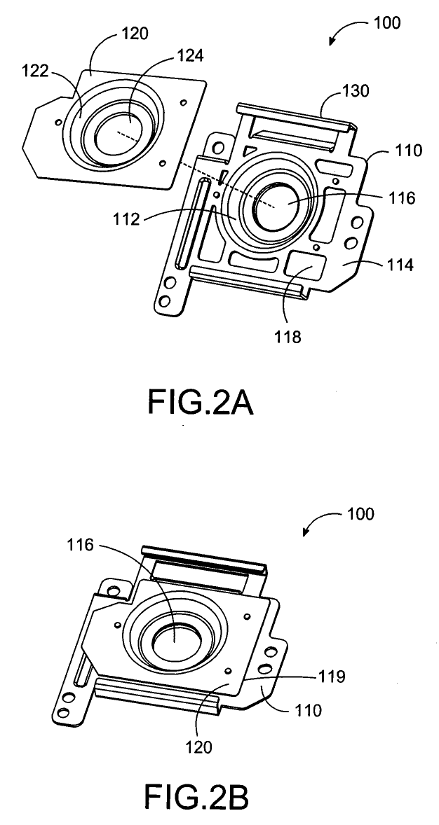

FIGS. 2A and 2B illustrate a light-shielding device 100 according to an embodiment of the present invention. As shown in FIG. 2A, the light-shielding device 100 includes a first component 110 and a second component 120. The first component 110 includes a circular element 112 and a frame 114. An aperture 116 is formed in the circular element 112, and the aperture 116 allows light emitted from the light source 12 incident onto the optical component 14. At least one opening 118 is formed in the frame 114. The second component 120 is coupled to the first component 110 for covering the opening 118.

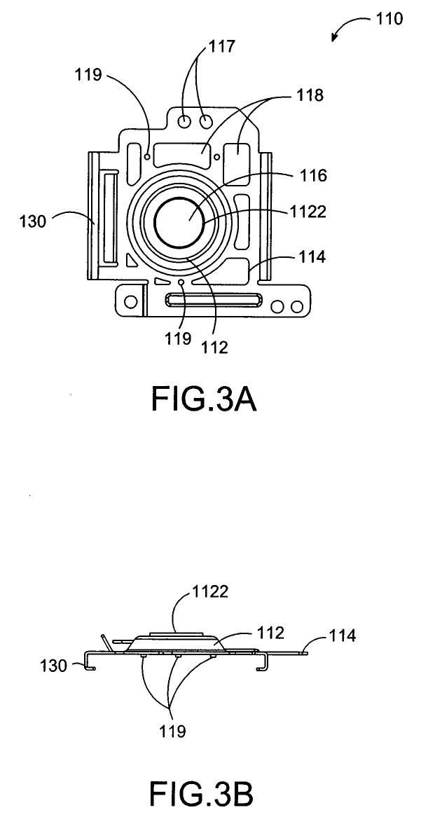

For example, the circular element 112 protrudes over the frame 114 and extends toward the optical component 14, so that the circular element 112 is closer to the optical component 14 than the frame 114, as shown in FIG. 1. Also FIG. 3A and FIG. 3B illustrate the first component 110 in different views. Then as shown in FIG. 2A, FIG. 3A, and FIG. 3B, the circular element 112 is a curved-surface structure, and the frame 114 is a plane structure. For example, the first component 110 is a saucer-like sunk structure, and the curved-surface structure extends from the frame 114. In this embodiment, the aperture 116 is the central opening at the bottom of the curved-surface structure.

In FIG. 3B, the circular element 112 further includes an extension portion 1122, which extends from the circular element 112 toward the optical component 14. In a way that surrounds with the aperture 116, the extension portion 1122 forms toward the color wheel 14, so that the light-shielding device 100 can further control the incident angle of the light with respect to the color wheel 14. Note that the size of the aperture 116, the radian of the curved-surface of the circular element 112, and the extending length of the extension portion 1122 are optimized so as to reduce the undesired stray lights, but not affect the amount of the desired incident light emitted onto the color wheel 14. In addition, as shown in FIG. 2A, the second curved-surface structure 112 includes a plurality of reflective surfaces, and the surfaces have different radians. Preferably, the radian is selected in order to maximize the light-shielding area and then to shield effectively the undesired light from the surroundings. For example, the larger the radian is, the better the shielding effect.

As shown in FIG. 2A and FIG. 2B, the second component 110 is configured to cover the opening 118 of the first component 110. The first component 110 has a first thickness, and the second component 120 has a second thickness. The first thickness is greater than the second thickness. In one embodiment, the first component 110 is a rigid metal frame, e.g., an aluminum frame or a steel frame, and the second component 120 is a flexible metal sheet such as an aluminum sheet. Preferably, the arrangement and the size of opening 118 of the first component 110 should not affect the rigid structure of the light-shielding device 100. More openings 118 or a larger area of the opening 118 would facilitate the flow of gas layer so as to lower the thermal absorption of the first component 110 and reduce the heat conduction in the axial direction (through the thickness of the first component 110) of the aperture 116. The way to arrange the second component 120 is mainly to cover the opening 118. A thinner second component 120 also lowers the heat conduction in the axial direction (in the direction of thickness) of the aperture 116. For example, the second component 120 is an aluminum sheet with a thickness in a range between 0.05 mm and 0.1 mm.

In another embodiment, the second component 120 can be a rigid metal sheet, including a second curved-surface structure 122 corresponding to the curved-surface structure 112 of the first component 110 and including a second aperture 124 corresponding to the aperture 116 of the first component 110. When the second component 120 is coupled to the first component 110, the second curved-surface structure 122 of the second component 120 overlaps the curved-surface structure 112 of the first component 110. The second curved-surface structure 122 includes a plurality of reflective surfaces, and the surfaces have different radians in order to effectively reflect the undesired light from the surroundings. In this embodiment, the first component 110 has a first reflectivity, and the second component 120 has a second reflectivity. The first reflectivity is smaller than the second reflectivity. In this embodiment, the first component 110 is made up of aluminum or other rigid metal materials. The first component 110 has a portion for reflecting undesired light, and this portion is substantially covered by the second component 120. Therefore, the light-shielding device 100 substantially relies on the second component 120 to reflect the undesired light. Accordingly, the reflectivity of the second component 120 is preferably greater than 0.8, more preferably than 0.9. Treated with a surface treatment, a Sn-coating polishing treatment, or an anode polishing treatment, the second component 120 can achieve the high reflectivity.

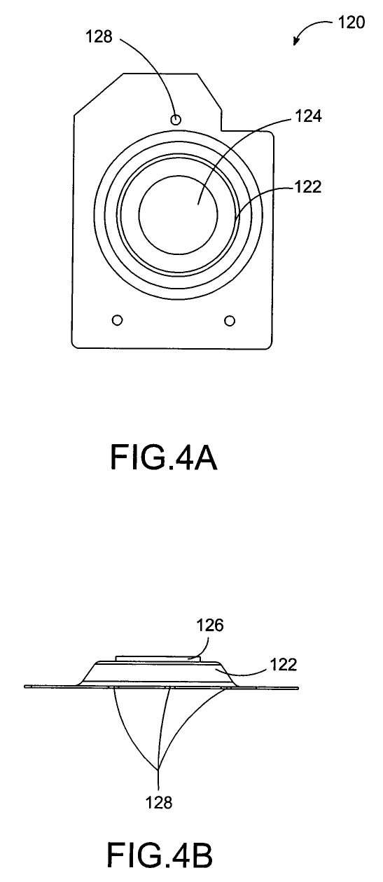

In another embodiment, when the second component 120 is coupled to the first component 110, a slit 119 between the first component 110 and the second component 120 allows gas to flow between the first component 110 and the second component 120. Due to the opening 118 and the slit 119 between the first component 110 and the second component 120, gas can flow within the light-shielding device 100, thus lowering the temperature of the light-shielding device 100 and improving the thermal environment of the optical component 14. The second component 120 further includes an extension portion 126 corresponding to the extension portion 1122 of the first component 110. In yet another embodiment, the first component 110 and the second component 120 selectively include several engaging elements, such as the protrusion 119 and the engaging hole 128 as shown in FIG. 3A and FIG. 4A, for connecting to the first component 110 with the second component 120. In other embodiments, however, the extension portions or the curved-surface structures of these two components can be modified, in order to connect the first component 110 with the second component 120 by engaging of the extension portions or the curved-surface structures without additional engaging elements. Alternatively, functioning as the second component 120, a flexible metal sheet can be used for attaching to the first component 110, without additional engaging elements.

Similarly, note that when the second component 120 is embodied as a rigid metal sheet, the radian of the second curved-surface of the circular element 122, the size of the aperture 114, and the extending length of the extension portion 126 are optimized so as to reduce the undesired surrounding light but not affect the amount of the desired incident light emitted onto the color wheel 14. In addition, as shown in FIG. 2A, the second curved-surface structure 122 may also include a plurality of reflective surfaces, and the surfaces have different radians. Preferably, the radian is selected in order to maximize the light-shielding area and then to shield effectively the undesired light from the surroundings.

In addition, when the second component 120 is embodied as a flexible metal sheet (e.g., aluminum sheet), the second component 120 selectively covers the curved-surface structure of the circular element 112 and then enhances the reflection of the circular element 112. In another embodiment, when the curved-surface structure of the circular element 112 is a high-reflective surface, the second component 120 may selectively only cover the opening 118, to prevent undesired light from reaching the color wheel 14. In another embodiment, the first component 110 includes a connecting portion 130 for connecting to the light source 12. That is, the light-shielding device 100 may be connected to the light source 12 via the connecting portion 130, or may be engaged with other components by an engaging hole 117 of the first component 110, as shown in FIG. 3A. In an embodiment, the connecting portion 130 is designed as a guiding groove, and the light source 12 has a corresponding track (such as the side frame of the light source). By placing the track into the guiding groove, the light-shielding device 100 is engaged with the light source 12.

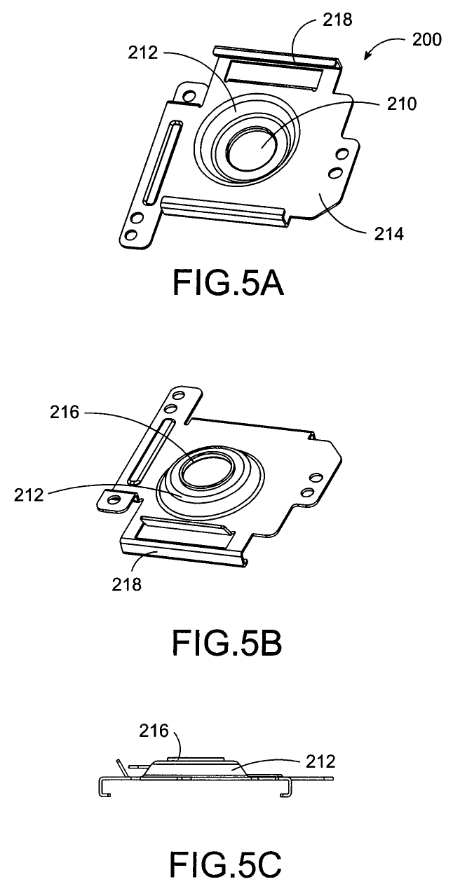

Referring to FIGS. 5A, 5B, and 5C, in an alternative embodiment, a light-shielding device 200 formed in a single piece includes a circular element 212 and a frame 214. The circular element 212 protrudes over the frame 214 and extends toward the optical component 14, so that the circular element 212 is closer to the optical component 14 than the frame 214. An aperture 210 is formed in the circular element 212, and the aperture 210 allows light emitted from the light source 12 incident onto the optical component 14. The light-shielding device 200 may be made up of a material with a reflectivity greater than 0.8, preferably than 0.9. Or the circular element 212 and the frame 214 are treated with a surface treatment, an Sn-coating polishing treatment, or an anode polishing treatment. In this embodiment, the structure of the light-shielding device 200 is similar to the first component 110 of the light-shielding device 100, in a way that the circular element 212 has an extension portion 216, the curved-surface structure of the circular element 212 includes reflecting curved surfaces of different radians, or the light-shielding device 200 selectively includes a connecting portion 218 for connecting to the light source 12. In this embodiment, the high reflection surface of the light-shielding device 200, as well as the increased reflecting area due to the curved-surface design of the circular element 212, results in the flow disturbance when the color wheel 14 rotates at a high speed, and the thermal environment of the color wheel 14 can thus be improved.

Accordingly, provided by the present invention, the image forming apparatus 10 having the light-shielding device 100 or the integrated light-shielding device 200 effectively blocks the undesired surrounding light and reduces the light absorption (i.e., the thermal absorption) of the light-shielding device. Thus the thermal environment of the optical component 14 is improved and then the quality of the image is enhanced.

While this invention has been described with reference to the illustrative embodiments, these descriptions should not be construed in a limiting sense. Various modifications of the illustrative embodiments, as well as other embodiments of the invention, will be apparent upon reference to these descriptions. It is therefore contemplated that the appended claims will cover any such modifications or embodiments as falling within the true scope of the invention and its legal equivalents.

1. A light-shielding device, disposed between a light source and an optical component of an image forming apparatus, the light-shielding device comprising:
a first component comprising a circular element and a frame, wherein an aperture is formed in the circular element and the aperture allows light emitted from the light source incident onto the optical component, and wherein an opening is formed in the frame; and
a second component coupled to the first component for covering the opening.

2. A light-shielding device according to claim 1, wherein the second component comprises a second aperture, and the second aperture is corresponding to the aperture of the first component.

3. A light-shielding device according to claim 1, wherein the first component has a first thickness, and the second component has a second thickness, and wherein the first thickness is greater that the second thickness.

4. A light-shielding device according to claim 3, wherein the second thickness is in a range between 0.05 mm and 0.1 mm.

5. A light-shielding device according to claim 1, wherein the first component has a first reflectivity, and the second component has a second reflectivity, and wherein the first reflectivity is smaller than the second reflectivity.

6. A light-shielding device according to claim 1, wherein the second component is a flexible metal sheet, and the first component is a rigid metal frame.

7. A light-shielding device according to claim 1, wherein the circular element protrudes over the frame and extends toward the optical component, so that the circular element is closer to the optical component than the frame.

8. A light-shielding device according to claim 1, wherein the circular element is a curved-surface structure, and the frame is a plane structure; and wherein the curved-surface structure extends from the frame.

9. A light-shielding device according to claim 1, wherein the circular element further comprises an extension portion, and the extension portion extends toward the optical component.

10. A light-shielding device according to claim 8, wherein the second component comprises a second curved-surface structure corresponding to the curved-surface structure, and wherein when the second component is coupled to the first component, the second curved-surface structure overlaps the curved-surface structure.

11. A light-shielding device according to claim 10, wherein the second curved-surface structure comprises a plurality of reflective surfaces, and the surfaces have different radians.

12. A light-shielding device according to claim 1, wherein when the second component is coupled to the first component, a slit between the first component and the second component allows gas flowing between the first component and the second component.

13. A light-shielding device according to claim 1, wherein the second component is treated with a surface treatment, an Sn-coating polishing treatment, or an anode polishing treatment.

14. A light-shielding device according to claim 1, wherein the first component further comprises a connecting portion for connecting to the light source.

15. A light-shielding device, disposed between a light source and an optical component of an image forming apparatus, the light-shielding device comprising:
a frame; and
a circular element, wherein the circular element protrudes over the frame and extends toward the optical component, so that the circular element is closer to the optical component than the frame; and
wherein an aperture is formed in the circular element and the aperture allows light emitted from the light source incident onto the optical component.

16. A light-shielding device according to claim 15, wherein the light-shielding device comprises a material with a reflectivity greater than 0.8.

17. A light-shielding device according to claim 15, wherein the frame and the circular element are treated with a surface treatment, a Sn-coating polishing treatment, or an anode polishing treatment.

18. A light-shielding device according to claim 15, wherein the circular element is a curved-surface structure, and the frame is a plane structure; and wherein the curved-surface structure extends from the frame.

19. A light-shielding device according to claim 18, wherein the curved-surface structure comprises a plurality of reflective surfaces, and the reflective surfaces have different radians.

20. An image forming apparatus comprising the light-shielding device of claim 1.

21. An image forming apparatus comprising the light-shielding device of claim 15.
